(19) United States
(12) Patent Application Publication
(10) Pub. No.: US 2013/0122465 A1
(43) Pub. Date: May 16, 2013

(54) Kit for cementation on dental implants

(71) Applicant: Tobias Hoffmann, Berlin (DE)

(72) Inventor: Tobias Hoffmann, Berlin (DE)

(73) Assignee: HOFFMANN DENTAL MANUFAKTUR GMBH, BERLIN (DE)

(21) Appl. No.: 13/293,474

(22) Filed: Nov. 10, 2011

(51) Int. Cl. A61C 13/225

(52) U.S. Cl. 433/180

(57) ABSTRACT

The present patent application relates to a kit for cementation on dental implants comprising
a) one or several predosed disposable packages containing a solid component (e.g. zinc oxide),
b) a dropper bottle consisting of dropper insert and container, containing an acid component (e.g. phosphoric acid), the dropper bottle dropwise dispensing the acid upon pressure on the container,
   the dropper insert being characterized in that it dispenses an exactly defined amount of acid per drop.

The present patent application relates to a kit for cementation on dental implants comprising
a) several predosed disposable packages containing zinc oxide and if applicable necessary admixtures such as magnesium oxide and calcium fluoride,
b) a dropper bottle consisting of dropper insert and container, containing aqueous phosphoric acid, the dropper bottle dropwise dispensing the phosphoric acid upon pressure on the container,
   the dropper insert being characterized in that it dispenses an exactly defined amount of phosphoric acid per drop.

### BACKGROUND AND PRIOR ART

Modern dental treatment requires a reliable fixation of inlays, crowns and bridges made from noble metals, the fixation of crowns and bridges made from zinc oxide, aluminum oxide and lithium disilicate ceramic, the cementation of crowns and bridges on implants, the fixation of orthodontic bands, the cementation of root posts and screws and temporary fillings. For the mentioned purposes, the use of so-called phosphate cement has proven successful. This zinc phosphate cement that has been developed by Dr. Otto Hoffmann already at the end of the 19^{th} century is usually mixed from powdery zinc oxide and aqueous phosphoric acid on a glass plate and promptly processed.

The properties of the resulting phosphate cement depend on the exact mixing conditions. For instance, the glass plate used for mixing must be as thick as possible, in order that the reaction heat generated by the reaction of zinc oxide and phosphoric acid is conducted away as quickly as possible. Otherwise, the heat would accelerate setting.

Further, it is essential to precisely adjust the mixing ratios, since otherwise the resulting cement will be either too liquid or too solid, and thus will differ from the optimum processing quality. Experiments have shown that when using too much liquid, the pressure resistance will be reduced, whereas the setting time and the solubility as well as the pulp toxicity will be increased.

It is important to note that for different applications (such as for instance core build-ups and linings) of course different cement consistencies or flow properties are required.

The usual procedure in the dental practice is that the assistant applies a certain amount of zinc oxide powder with a spatula on a glass plate, and then adds phosphoric acid solution with a conventional dropper bottle. Both components are then stirred by means of a spatula.

An important problem in this context is that the application of powder and solution is a subjective decision, even for an experienced assistant, since a reproducible adjustment of the amount by visual inspection is difficult. Another problem is that the used zinc oxide powder can easily be compressed. The dental assistant does not determine the amount of used zinc oxide powder by the weight, but by the volume (by visual inspection). Due to the compressibility of the zinc oxide, the same volume may however mean a completely different amount of zinc oxide. Further, the addition of phosphoric acid by means of a conventional dropper bottle is also very inaccurate: The size of the drops may very strongly vary—e.g. depending on the pressure exerted on the bottle or on the filling level.

When preparing the phosphate cement, the dentist or the dental assistant must therefore mainly rely on their experiences in order to find out, whether the resulting cement mixture is suitable for the respective application. If the mixture is evidently too solid, a new mixture has to be prepared. If the mixture is evidently too liquid, more zinc oxide powder is added.

It is therefore immediately understandable that the exact adjustment of the desired cement quality faces difficulties and is in part accidental.

For overcoming the above mentioned drawbacks, it has been proposed, in prior art, to use a capsule system with predosed powder and liquid components that are mixed by means of a high-frequency shaker. In this solution it has been found as disadvantageous that the exothermal reaction of the mixing of phosphate cement made the finished cement mixture quickly hard, which required a series of counter-measures: cooling the capsule before the mixing process (shaking), reaction retarding additives in an overall very aqueous solution. Furthermore, the capsule dispenses one defined cement quality having a certain consistency only: The adjustment of the desired flow properties of the cement (“more liquid” or “more solid”) for different applications is not possible.

There is further a demand of solutions for preparing tooth cements allowing a sufficiently reproducible cement quality, together with an adjustable flow property and thus different consistencies to be defined accurately.

### DESCRIPTION OF THE INVENTION

It has been found that a kit for cementation on dental implants comprising one or several predosed disposable packages containing the solid component of the tooth cement—in particular zinc oxide and if applicable necessary admixtures such as magnesium oxide and calcium fluoride—, and a dropper bottle containing the aqueous acid component—in particular phosphoric acid surprisingly overcomes the drawbacks of prior art.

This is for instance a kit comprising disposable packages containing predosed zinc oxide powder and a dropper bottle containing aqueous phosphoric acid, the dropper bottle being configured such that the drop size is always constant, independently from the pressure on the bottle.

The object if achieved, according to the invention, by providing a kit for cementation on dental implants comprising
a) one or several predosed disposable packages containing a solid component,
b) a dropper bottle consisting of dropper insert and container, containing an acid component, the dropper bottle dropwise dispensing the acid upon pressure on the container,
   the dropper insert being characterized in that it dispenses an exactly defined amount of acid per drop.

In this way, an exact adjustment of the properties of the tooth cement, in particular its flow properties can be effected. Dropper bottles of the mentioned species are in particular known from the US 2004/0050881A (EP 1368245 B1). The content of these patent documents is herewith included by reference.

These dropper bottles are composed of a deformable container and a dropper insert, in said dropper insert a discharge channel and a restrictor device being arranged that are firmly arranged in the flow direction upstream of the intake opening of the discharge channel. This dropper insert is characterized by that the restrictor device is arranged at a distance from the intake opening, and that between the intake opening and the restrictor device, an intermediate chamber is arranged that is defined by the bottom wall of the dropper insert and a chamber wall.

The further features of such dropper bottles are known from the document US 2004/0050881A (EP 1368245 B1), to which reference is explicitly made herewith. In the mentioned document, the “dropper insert” described here is also called “dropper cap”.

Alternatively, the following configuration of the dropper bottle is possible: The deformable container that receives the liquid is closed by a thin membrane having a small opening acting as a restrictor device. The dimension of this restrictor device is adjusted to the properties of the liquid and the desired dosage. The dropper insert is located in the orifice of the dosing tube and transforms the liquid flow passing through the restrictor device into drops of the desired size.

In any case, it is decisive for carrying-out the invention that the accuracy of the drop size (measured as standard deviation σ of the drop weight) is less than 10%. In a preferred embodiment of the invention, the accuracy (standard deviation σ of the drop weight) is less than 6%, particularly preferably less than 4%.

The zinc oxide-containing disposable packages contain a defined amount of the zinc oxide. This may if applicable also contain small additions of magnesium oxide and calcium fluoride, the zinc oxide share not exceeding 90%. The disposable packages contain a predefined amount of the zinc oxide (for instance 0.5 g, 0.75 g, 1.0 g, 1.25 g, 1.5 g, 1.75 g, 2.0 g etc.), so that in use always the same amount is available, which is not determined by visual evidence, and there is no need of other weighing or dosing equipment.

For special applications, the zinc oxide further contains admixtures of silver and/or copper. The admixture may be colloidally dispersed silver and/or copper. Silver and copper may however also be admixed in the form of oxides or hydroxides. In preferred embodiments, the admixture is made in the form of physiologically tolerated salts, for instance in the form of chlorides, phosphates, nitrates, iodides, carbonates, hydrogen phosphates, silicates or mixtures thereof. The admixture may for instance be 0.5 to 10 wt. % copper and/or 0.5 to 10 wt. % silver, and the total of the admixtures should not be much larger than 10 wt. %.

In a particularly preferred embodiment of the invention, the zinc oxide contains 1 to 10 wt. %, preferably 1.5 to 4 wt. %, particularly preferably 2 wt. % copper rhodanide (also known as copper thiocyanate).

Such embodiments containing silver and/or copper are advantageous due to the better antibacterial properties of the composition.

The pressure bottle contains the aqueous phosphoric acid solution. This may be a 54 or 56% phosphoric acid solution. The phosphoric acid contains, if applicable, admixtures of zinc oxide and aluminum hydroxide.

The dropper bottle dispenses upon pressure individual drops of the phosphoric acid solution, the weight of an individual drop always being constant, as described above (standard deviation σ of the drop weight less than 10%, preferably less than 6%, particularly preferably less than 4%). The drop weight is adjusted to the properties of the filled-in material, the desired dosage and the number of drops. Preferably, the drop weight for the phosphoric acid solution mentioned above is 0.095 g.

By pressure on the bottle and counting the drops, the dentist or the assistant can exactly determine the phosphoric acid solution for mixing the cement. For instance, the disposable packages can contain exactly 1 g zinc oxide. This can be mixed with 7 drops of 0.095 g each to a phosphate cement being suitable for the fixation of crowns made of noble metal on teeth. If the dentist wishes a more flowable cement, for instance for the cementation of crowns and bridges of precisely CAD/CAM milled high-quality ceramics, the dosage may be increased to 8 drops of 0.095 g phosphoric acid solution each. If the dentist needs a rather paste-like cement, for instance for the cementation of root posts and screws, he or she may use less drops, for instance 6 drops of 0.095 g each.

A particular advantage of the kit according to the invention is that the obtained cement quality is always precisely defined, and the composition can easily be documented. This is of course not possible for the various techniques being known from prior art.

Per kit, preferably, several predosed disposable packages comprising the respective solid component and a dropper bottle containing the acid component are included. In individual cases, a single package of solid material and a single dropper bottle may be included. Alternatively, it is possible that several predosed disposable packages containing zinc oxide and several dropper bottles are provided in a kit, wherein for instance one dropper bottle contains carbonic acids and another dropper bottle contains phosphoric acid. Since the basic idea of the invention is to simplify the mixing process in the dental clinic, the kit will preferably contain just one solid component (preferably in several predosed disposable packages) and one acid component (preferably in a single dropper bottle).

For the disposable package of the solid material, in particular zinc oxide, various packaging materials can be used, in particular films. Particularly important is the blocking capability against water and water vapor, but also against other gases such as carbon dioxide. According to the invention, a composite film of PET (polyethylene terephthalate)/aluminum/PE (polyethylene) has proven successful. Other packages are imaginable, without departing from the general idea the invention is based on.

The kit according to the invention is furthermore suitable for the production of polycarboxylate cements or glass ionomer cements. In the polycarboxylate cements, zinc oxide will also be used as a solid component. Instead of phosphoric acid, however, an aqueous solution of carbonic acids (e.g. polycarbonic acids such as polyacrylic acid, but also acrylic acid, methacrylic acid, itaconic acid, maleic acid, and mixtures thereof) is used as an acid component. The carbonic acid solution may contain, if applicable, further components in small amounts, such as for instance zinc oxide and aluminum hydroxide or calcium oxide.

In the glass ionomer cements, glass powder (containing ground, fluoride-containing, aluminum-rich silicate glass) is used as a solid component. The acid component is an aqueous solution of carbonic acids (e.g. polycarbonic acids, such as polyacrylic acid, but also acrylic acid, methacrylic acid, itaconic acid, maleic acid, and mixtures thereof), if applicable with additional components.

Other dental cements are imaginable, without departing from the general idea the invention is based on.

1. A kit for cementation on dental implants comprising
a) one or several predosed disposable packages containing a solid component,
b) a dropper bottle consisting of dropper insert and container, containing an acid component, the dropper bottle dropwise dispensing the acid upon pressure on the container,
the dropper insert being characterized in that it dispenses an exactly defined amount of acid per drop.

2. The kit for cementation on dental implants according to claim 1, characterized in that the predosed disposable package contains 0.5 to 2 g, preferably 1 g zinc oxide powder.

3. The kit for cementation on dental implants according to claim 2, characterized in that the zinc oxide powder contains 0.5 to 10 wt. % copper and/or 0.5 to 10 wt. % silver in colloidal form, in the form of oxides, hydroxides and/or in the form of a physiologically tolerated salt.

4. The kit for cementation on dental implants according to claim 3, characterized in that the zinc oxide powder contains 1 to 10 wt. % copper rhodanide.

5. The kit for cementation on dental implants according to claim 1, characterized in that the predosed disposable package contains 0.5 to 2 g, preferably 1 g glass powder.

6. The kit for cementation on dental implants according to claim 5, characterized in that the predosed disposable package contains 0.5 to 2 g, preferably 1 g ground, fluoride-containing, aluminum-rich silicate glass.

7. The kit for cementation on dental implants according to claim 1, characterized in that the dropper bottle contains 5 to 20 ml of the acid component, preferably 10 ml.

8. The kit for cementation on dental implants according to claim 1, characterized in that the dropper bottle contains 5 to 20 ml of aqueous phosphoric acid, preferably 10 ml.

9. The kit for cementation on dental implants according to claim 1, characterized in that the dropper bottle contains 5 to 20 ml of the carbonic acid component, preferably 10 ml.

10. The kit for cementation on dental implants according to claim 9, characterized in that the dropper bottle contains 5 to 20 ml of an aqueous solution of carbonic acids (e.g. polycarbonic acids such as polyacrylic acid, but also acrylic acid, methacrylic acid, itaconic acid, maleic acid, and mixtures thereof), preferably 10 ml.
